(19) United States
(12) Patent Application Publication
(10) Pub. No.: US 2012/0123851 A1
(43) Pub. Date: May 17, 2012

(54) CLICK EQUIVALENT REPORTING AND RELATED TECHNIQUE

(75) Inventors: Eric Theodore Bax, Altadena, CA (US); Darshan V. Kantak, Pasadena, CA (US); Dz-Mou Jung, Mercer Island, WA (US)

(73) Assignee: Yahoo! Inc., Sunnyvale, CA (US)

(21) Appl. No.: 12/945,620

(22) Filed: Nov. 12, 2010

(51) Int. Cl. G06Q 30/00

(52) U.S. Cl. 705/14.41; 705/14.71

(57) ABSTRACT

Techniques are provided for use in online advertising, such as sponsored search advertising. Information may be obtained that includes historical online advertising information including information relating to conversion rates associated with bid amounts or bid amount ranges, as well as a proposed advertiser bid amount or bid amount range. Based at least in part on obtained information, a forecasted or predicted conversion rate or conversion rate range associated with the proposed bid amount or bid amount range is determined, and associated reporting is provided to the advertiser, which may include click equivalent information associated with a bidding-related standard or benchmark.

### BACKGROUND

In online advertising, such as search-based or sponsored search advertising, advertisers (including their agents or other proxies) may bid in relation to keywords and keyword terms. The amount of the bid may relate or correspond to an amount an advertiser may pay, for example, for each associated user click. The amount of the bid may influence, for example, the rank or prominence with which associated advertisements are displayed, and may influence other advertising or advertisement performance-related factors as well.

Although the advertiser may pay based on, or based in part on, clicks, the advertiser may receive value on a different basis, such as on the basis of conversions associated with clicks. A conversion may include a user action that results in value to the advertiser, such as a user purchase, for instance.

Although an advertiser may pay in relation to clicks, the advertiser's return on investment may be associated with the conversion rate, for example. As such, incomplete, incorrect or unclear information associated h conversion rates, such as a forecasted or predicted conversion rate associated with a particular bid amount or level, for example, can lead to a poorly informed advertiser. Such a poorly informed advertiser may, for example, make poor advertising or bidding decisions or may not realize potential or likely value in particular bidding strategies. This can in turn lead to, for example, poor advertiser engagement as well as lower and less optimal advertiser spend.

There is a need for techniques relating to informing advertisers with regard to value that may be associated with different bids, bidding levels, or bidding strategies, for example.

### SUMMARY

In some embodiments, techniques are provided for se in online advertising, such as sponsored search advertising. In some embodiments, information is obtained that includes historical online advertising information including information relating to conversion rates associated with bid amounts or bid amount ranges, as well as a proposed advertiser bid amount or bid amount range. Based at least in part on obtained information, a forecasted or predicted conversion rate or conversion rate range associated with the proposed bid amount or bid amount range is determined, and associated reporting is provided to the advertiser, which may include click equivalent information associated with a bidding-related standard or benchmark.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating a method according to one embodiment of the invention; and

FIG. 5 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

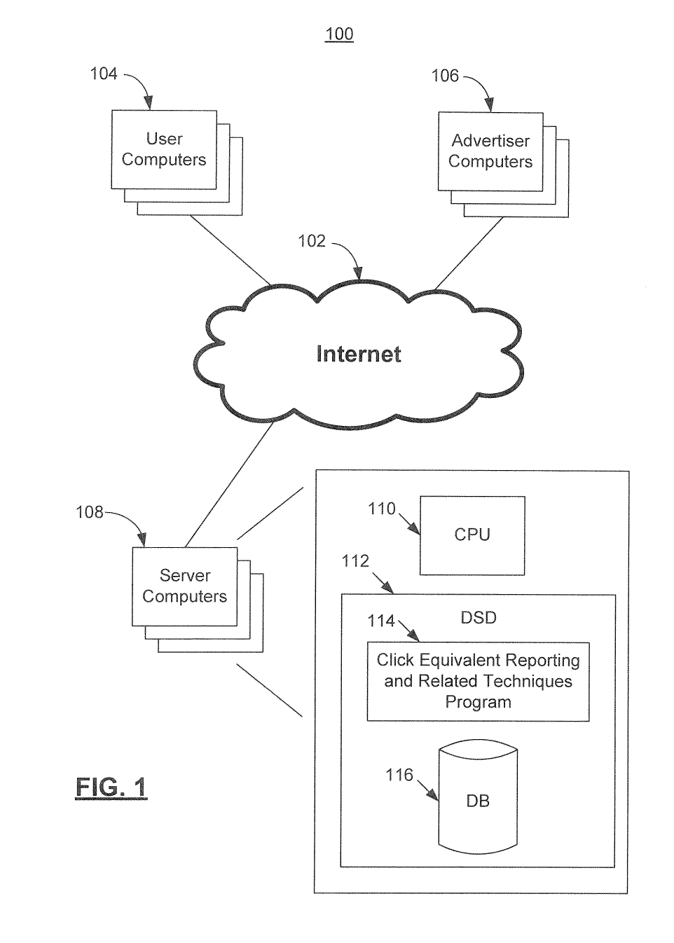

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Click Equivalent Reporting and Related Techniques Program 114.

The Program 114 is intended to broadly include all programming, applications, algorithms, software and other and tools necessary to implement or facilitate methods and systems according to embodiments of the invention, including techniques that may not utilize click equivalent measures or reporting. The elements of the Program 114 may exist on a single server computer or be distributed among multiple computers or devices.

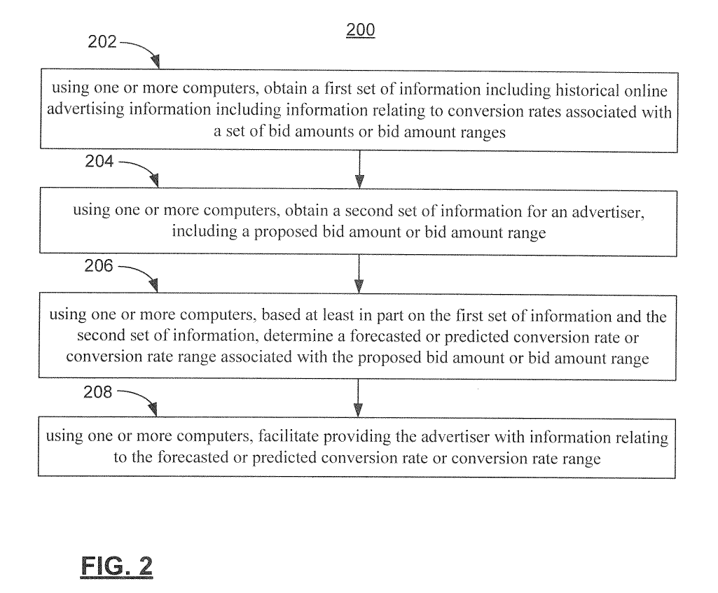

FIG. 2 is a flow diagram illustrating a method 200 according to one embodiment of the invention. At step 202, using one or more computers, a first set of information is obtained, including historical online advertising information including information relating to conversion rates associated with a set of bid amounts or bid amount ranges.

At step 204, using one or more computers, a second set of information is obtained for an advertiser, including a proposed bid amount or bid amount range.

At step 206, using one or more computers, based at least in part on the first set of information and the second set of information, a forecasted or predicted conversion rate or conversion rate range is determined, associated with the proposed bid amount or bid amount range.

At step 208, using or more computers, the method 200 includes facilitating providing the advertiser with information relating to the forecasted or predicted conversion rate or conversion rate range.

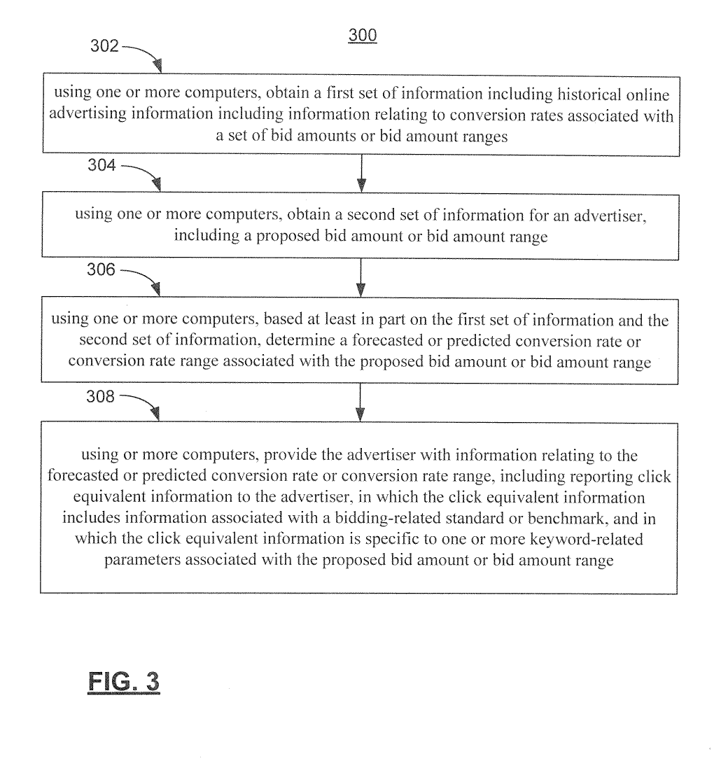

FIG. 3 is a flow diagram illustrating a method 300 according to one embodiment of the invention. Steps 302 to 306 are similar to steps 202-206 as depicted in FIG. 2.

At step 308, using or more computers, the advertiser is provided with information relating to the forecasted or predicted conversion rate or conversion rate range, including reporting click equivalent information. The click equivalent information includes information associated with a bidding-related standard or benchmark. The click equivalent information is specific to one or more keyword-related parameters associated with the proposed bid amount or bid amount range.

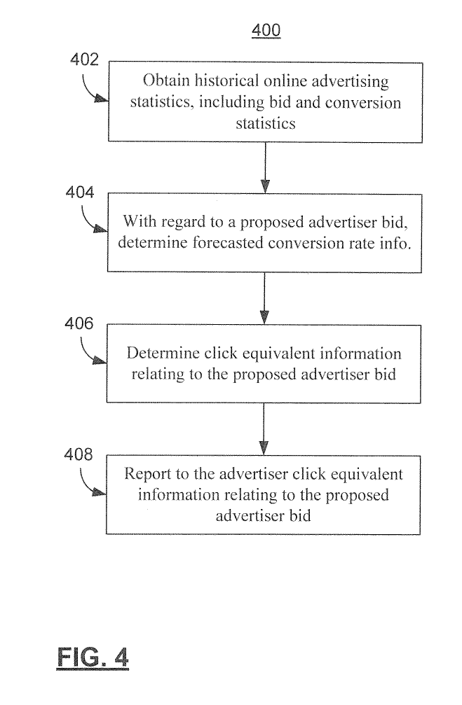

FIG. 4 is a flow diagram illustrating a method 400 according to one embodiment of the invention. At step 402, historical online advertising statistics are obtained, including bid and conversion statistics.

At step 404, with regard to a proposed advertiser bid, forecasted conversion rate information is determined. Herein, the term “proposed”, such as used in “proposed bid amount”, etc., broadly includes a hypothetical or possible bid, etc., whether or not actual bidding is contemplated utilizing the proposed bid amount.

At step 406, click equivalent information is determined, relating to the proposed advertiser bid.

At step 408, reporting is provided to the advertiser, including click equivalent information relating to the proposed advertiser bid.

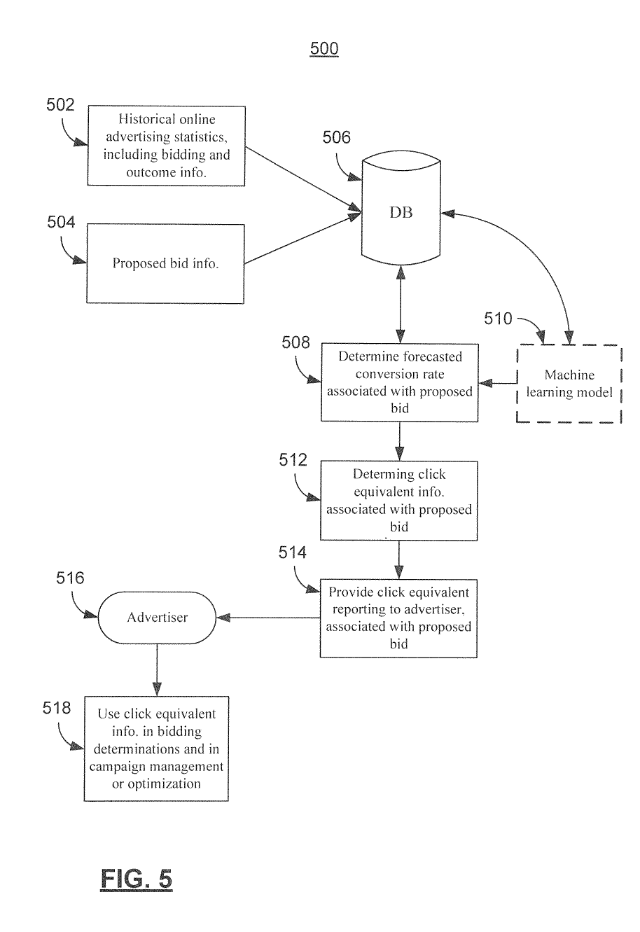

FIG. 5 is a block diagram 500 illustrating one embodiment of the invention. As depicted, various information is stored in one or more databases 506, including historical online advertising statistics, including bidding and outcome information 502, and proposed bid information 504.

As represented by block 508, using information stored in the database 506, forecasted conversion rate information is determined, associated proposed bid, which may then be stored in the database 506 or elsewhere. One or more machine learning models 510 may be utilized in making the determination, along with information including historical bidding information.

In some embodiments, collected bid statistics from many advertisers may be utilized in making the determination. Alternatively or additionally, in some embodiments, sample bid statistics of the advertiser associated with the proposed bid may be utilized to obtain information which can be used in making the determination.

As represented by block 512, click equivalent information is determined, associated with the proposed bid and based at least in part on the determined forecasted conversion rate information.

As represented by block 514, click equivalent reporting is provided to advertiser 516 associated with proposed bid.

Block 518 represents use of the click equivalent information in making or optimizing bidding determinations and in online advertising campaign management or optimization.

Some embodiments of the invention can be used in connection with search advertising marketplaces. A description of an example advertising marketplace and associated features is provided, although embodiments of the invention contemplate many different contexts and variations. Often, in a search advertising market, advertisers participate by selecting a set of keywords and setting a bid for each keyword. An advertiser's bid for a keyword may be the amount the advertiser is willing to pay for each click on their advertisement when it is shown on a search results page for a query corresponding to the keyword. For example, an advertiser who sells watermelons may bid on the keywords “watermelon”, “melon” and “summer fruit.”

When a user types in a query corresponding to one of these keywords, the search engine may show a results page search results. The results page may also include a set of advertisements, selected by the search advertising market-maker. The advertisements may be selected based on their advertisers' bids on the keyword, among other factors. The selection process may be called an auction.

The selected advertisements may be shown in different positions on the search results page. More noticeable positions may be called higher positions. An advertiser may obtain a higher position on the results page for a keyword by increasing their bid on that keyword. The higher position may cost the advertiser more per click, but it also may yield more clicks.

In addition to paying per click, the advertiser may also have one-time setup fees and recurring overhead costs. As such, the advertiser may need to receive enough overall value to cover these costs as well as the cost per click. Often, the advertiser receives value when a click leads to a conversion, such as a sale.

An advertiser may need to determine, for example, how much to bid, such as in connection with a set of keywords, or whether to increase or decrease a bid that the advertiser has previously utilized. Without better information, an advertiser may assume that conversion rates on a per click basis may generally remain constant when a bid amount is changed, even though this may not in fact be the case, for any of a variety of possible reasons, including but not necessarily limited to differing advertisement positions associated with different bids. Assuming that it is not the case, then, based on poor information, the advertiser may make suboptimal bidding decisions, leading to suboptimal campaign performance and suboptimal return on investment. Furthermore, assuming that conversion rate would increase if the advertiser were to bid higher, then the advertiser, not being aware of this, may elect not only to bid lower, but to spend less on the online advertising.

Some embodiments of the invention, by better informing an advertiser, allow the advertiser to recognize that a higher bid may lead to not only more clicks but also a higher conversion rate. This, in turn, may lead to the advertiser determining a higher bid as being optimal, and then bidding higher, which may lead to a better return on investment and encourage the advertiser to spend more on the advertising. This in turn, can increase revenue and profitability for the marketplace as a whole as well as various other participants in the marketplace, such as publishers and market-makers or marketplace facilitators, etc.

For example, a dynamic can emerge as follows. An advertiser may test the market with a low bid. The advertiser may receive a few clicks and measure a low conversion rate per click. The advertiser may be informed of how many more clicks they are likely to receive for different increases in their bid. The advertiser may reason that it is not worthwhile to pay more per click to get more clicks that convert as poorly as the inexpensive clicks they have bought, for example. So the advertiser may keep the low bid, or worse, decides that such a low level of participation does not justify the overhead cost and withdraws from the auction altogether, for example.

Some embodiments of the invention, by contrast, communicate to advertisers the value they will receive by increasing their bids to achieve higher positions in keyword auctions. Some embodiments include informing advertisers of the conversions to be obtained by raising their bids, rather than just the clicks. Some embodiments in a sense discount clicks reported to advertisers from low-converting inventory or positions, so that the discounted clicks have about the same conversion rate per click as the clicks to be obtained by raising bids.

In some embodiments, by providing advertisers with forecasts or predictions (which can include estimates) of how many conversions they are likely to receive at different bid levels, they can then combine this information with their own knowledge of their value per conversion to estimate the returns for different potential bids. For example, some techniques to obtain estimates of the numbers of conversions include exploring positions on behalf of the advertiser, adjusting the advertiser's bid in some auctions to obtain different positions, and measuring conversion rates for each position. The measured rates may provide a basis for statistics on future conversion rates for different positions. The advertiser may specify how much of a budget should be used for this purpose. In some embodiments, machine learning models or techniques may be utilized, such as using regression-based or model-fitting techniques to estimate the conversion rates per position for the advertiser and keyword(s) of interest based on observed historical conversion rates for similar advertisers and similar keywords. Such a sampling method may focus on the advertiser and keyword of interest, but it may be expensive, especially if the conversion rates are low, requiring many samples to accurately estimate them.

In some embodiments, click equivalent techniques are utilized. For example, some such techniques utilize a benchmark position's click as a standardized click. Click counts for other positions are adjusted so that the same adjusted click counts yield approximately the same number of conversions for all positions.

For example, in a sponsored search context, and assuming conversion rates per click vary depending on position, suppose a highest position is associated with a benchmark. The ratio of conversions to clicks (conversion rate) in the benchmark position is 0.10. Another position has conversion rate 0.05. The advertiser bids enough to obtain that position, and it yields 100 clicks. Some embodiments include reporting to the advertiser that the position yielded 50 standard click equivalents, because 50 clicks in the benchmark position would yield as many conversions as the 100 clicks in the obtained position. In some embodiments, a formula to convert clicks in a position i to standard click equivalents is:

cₛ=(rᵢ/r_{b})cᵢ, (Eq. 1)

Where cₛ is the number of standard click equivalents, rᵢ is the conversion rate per click in position i, r_{b} is the conversion rate per click in the benchmark position, and cᵢ is the number of clicks obtained in position i.

In some embodiments, each standard click equivalent has the same conversion rate. So once advertisers have estimates of how many standard click equivalents they can obtain at different positions, the advertisers can calculate the value they expect to receive from bidding sufficient amounts to obtain those positions. For example, if they are also informed of how much they need to bid to obtain different positions, then they can set bids to maximize returns on investment. Estimates of standard click equivalent counts may be based on conversion rates.

While the invention described with reference to the above drawings, the drawings are intended to be illustrative, and the invention contemplates other embodiments within the spirit of the invention.

1. A method comprising:
using one or more computers, obtaining a first set of information comprising historical online advertising information including information relating to conversion rates associated with a set of bid amounts or bid amount ranges;
using one or more computers, obtaining a second set of information for an advertiser, comprising a proposed bid amount or bid amount range;
using one or more computers, based at least in part on the first set of information and the second set of information, determining a forecasted or predicted conversion rate or conversion rate range associated with the proposed bid amount or bid amount range; and
using one or more computers, facilitating providing the advertiser with information relating to the forecasted or predicted conversion rate or conversion rate range.

2. The method of claim 1, wherein facilitating providing the advertiser with information relating to the forecasted or predicted conversion rate or conversion rate range comprises facilitating providing the advertiser with click equivalent information.

3. The method of claim 1, wherein facilitating providing the advertiser with information relating to the forecasted or predicted conversion rate or conversion rate range comprises facilitating providing the advertiser with click equivalent information, and wherein the click equivalent information comprises information associated with a bidding-related standard or benchmark, and wherein the click equivalent information is specific to one or more keyword-related parameters associated with the proposed bid amount or bid amount range.

4. The method of claim 1, comprising obtaining a proposed bid amount or bid amount range, wherein the proposed bid amount or bid amount range relates to sponsored search bidding.

5. The method of claim 1, comprising obtaining a proposed bid amount or bid amount range, wherein the proposed bid amount or bid amount range relates to at least one bid relating to one or more search keywords.

6. The method of claim 1, wherein obtaining a first set of information comprises obtaining statistical information relating to sample bidding of the advertiser, and outcome associated with the sample bidding.

7. The method of claim 1, wherein obtaining a first set of information comprises obtaining statistical information relating to bidding of advertisers other than the advertiser, and outcome associated with the bidding.

8. The method of claim 1, wherein facilitating providing the advertiser with information relating to the forecasted or predicted conversion rate or conversion rate range comprises reporting the information to the advertiser.

9. The method of claim 1, wherein facilitating providing the advertiser with information relating to the forecasted or predicted conversion rate or conversion rate range comprises reporting click equivalent information to the advertiser.

10. The method of claim 1, wherein determining a forecasted or predicted conversion rate or conversion rate range associated with the proposed bid amount or bid amount range comprises utilizing a modeling technique.

11. The method of claim 1, wherein determining a forecasted or predicted conversion rate or conversion rate range associated with the proposed bid amount or bid amount range comprises utilizing a machine learning technique.

12. The method of claim 1, wherein higher proposed bid amounts or bid amount ranges are associated with higher advertisement positions.

13. The method of claim 1, wherein higher proposed bid amounts or bid amount ranges are associated with higher advertisement positions, and wherein conversion rates associated with higher proposed bid amounts or bid amount ranges can be different than conversion rates associated with lower proposed bid amounts or bid amount ranges at least in part due differences associated with different advertisement positions.

14. A system comprising:
one or more server computers coupled to a network; and
one or more databases coupled to the one or more server computers;
wherein the one or more server computers are for:
obtaining a first set of information comprising historical online advertising information including information relating to conversion rates associated with a set of bid amounts or bid amount ranges;
obtaining a second set of information for an advertiser, comprising a proposed bid amount or bid amount range;
based at least in part on the first set of information and the second set of information, determining a forecasted or predicted conversion rate or conversion rate range associated with the proposed bid amount or bid amount range; and
facilitating providing the advertiser with information relating to the forecasted or predicted conversion rate or conversion rate range.

15. The system of claim 14, wherein at least one or the one or more server computers are coupled to the Internet.

16. The system of claim 14, comprising storing a forecasted or predicted conversion rate or conversion rate range in at least one of the one or more databases.

17. The system of claim 14, wherein facilitating providing the advertiser with information relating to the forecasted or predicted conversion rate or conversion rate range comprises facilitating providing the advertiser with click equivalent information.

18. The system of claim 14, wherein facilitating providing the advertiser with information relating to the forecasted or predicted conversion rate or conversion rate range comprises reporting the information to the advertiser.

19. The system of claim 14, wherein facilitating providing the advertiser with information relating to the forecasted or predicted conversion rate or conversion rate range comprises facilitating providing the advertiser with click equivalent information, and wherein the click equivalent information comprises information associated with a bidding-related standard or benchmark, and wherein the click equivalent information is specific to one or more keyword-related parameters associated with the proposed bid amount or bid amount range.

20. A computer readable medium or media containing instructions for executing a method comprising:
using one or more computers, obtaining a first set of information comprising historical online advertising information including information relating to conversion rates associated with a set of bid amounts or bid amount ranges;
using one or more computers, obtaining a second set of information for an advertiser, comprising a proposed bid amount or bid amount range;
using one or more computers, based at least in part on the first set of information and the second set of information, determining a forecasted or predicted conversion rate or conversion rate range associated with the proposed bid amount or bid amount range; and
using one or more computers, providing the advertiser with information relating to the forecasted or predicted conversion rate or conversion rate range, comprising reporting click equivalent information to the advertiser, wherein the click equivalent information comprises information associated with a bidding-related standard or benchmark, and wherein the click equivalent information is specific to one or more keyword-related parameters associated with the proposed bid amount or bid amount range.
